(19) United States
(12) Patent Application Publication
(10) Pub. No.: US 2011/0062041 A1
(43) Pub. Date: Mar. 17, 2011

(54) Packing container having temperature adjustment functions, and apparatus and method for manufacturing the same

(76) Inventor: Park Jun Bum, Seoul (KR)

(21) Appl. No.: 12/560,580

(22) Filed: Sep. 16, 2009

(51) Int. Cl. B65D 73/00; F25D 5/00; F24J 1/00; B65B 43/42; B31B 41/02

(52) U.S. Cl. 206/484; 62/4; 126/263.01; 53/574; 493/210

(57) ABSTRACT

There is provided a packing container. The packing container has two different spaces formed by pressing edges of a carrier sheet, a function sheet and a middle sheet to each other to form a carrier space and a function space in both sides of the middle sheet, and thus two contents may be packed in one packing container, which leads to the simple packaging handling.

### BACKGROUND OF THE INVENTION

1. Field of the Invention

The present invention relates to a packing container, and more particularly, to a packing container having two different spaces formed by pressing edges of a carrier sheet, a function sheet and a middle sheet to each other to form a carrier space and a function space in both sides of the middle sheet, which is able to pack two contents in one packing container and to cool or warm the contents through the cooling or exothermic reactions

2. Description of the Related Art

In general, packing containers are increasingly used to contain packaging contents, prevent the penetration of foreign substances, and store and carry the packaging contents for a long time. In particular, packing containers should be kept airtight since the freshness of packaged contents is important in packaging foods and the maintenance of moisture is important in packaging a beauty mask pack.

However, conventional packing containers have problems in that since only one content is contained in one packing container, a plurality of packing containers are required to realize the use of various contents, and that two contents are mixed when the two contents are included in one packing container. Also, it is difficult to make suitable conditions for use of the contents since it is just possible to contain the contents in one packing container but it is impossible to adjust a temperature of the contents.

### SUMMARY OF THE INVENTION

The present invention is designed to solve some of the problems of the prior art, and therefore it is an object of the present invention to provide a packing container having temperature adjustment functions, wherein each of a carrier sheet 100, a function sheet 200 and a middle sheet 300 has side sealing portions 350 formed in both ends thereof, the side sealing portions 350 being pressed and attached to each other, wherein each of the carrier sheet 100 and the middle sheet 300 has bottom-of-carrier sealing portions 150 formed in lower portions thereof, the bottom-of-carrier sealing portions 150 being pressed and attached to each other and being formed in a position spaced upwards apart from the lower end of the middle sheet 300, thereby forming a carrier space 130 between the carrier sheet 100 and the middle sheet 300, the carrier space 130 having an opened upper portion, and wherein each of the function sheet 200 and the middle sheet 300 has top-of-function-sheet sealing portions 240 formed in upper portions thereof, the top-of-function-sheet sealing portions 240 being pressed and attached to each other, and the top-of-function-sheet sealing portion 200 being formed in a position spaced downwards apart from the upper end of the middle sheet 300, thereby forming a function space 230 between the function sheet 200 and the middle sheet 300, the function space 230 having an opened lower portion and containing a cooling member or a heating member.

Also, it is another object of the present invention to provide a packing container having temperature adjustment functions, wherein each of a carrier sheet 100, a function sheet 200 and a middle sheet 300 has side sealing portions 350 formed in both sides thereof, the side sealing portions 350 being pressed and attached to each other, wherein each of the carrier sheet 100 and the middle sheet 300 has a top-of-carrier sealing portion 140 and a bottom-of-carrier sealing portion 150 formed respectively in upper and lower portions thereof, the top-of-carrier sealing portion 140 and the bottom-of-carrier sealing portion 150 being pressed and attached to each other, and the top-of-carrier sealing portions 140 being formed in the upper end of the middle sheet 300 and the bottom-of-carrier sealing portion 150 being formed in a position higher than the bottom-of-function-sheet sealing portion 250 of the function sheet 200 so that the bottom-of-carrier sealing portion 150 is spaced upwards apart from the lower end of the middle sheet 300, thereby forming a carrier space 130 between the carrier sheet 100 and the middle sheet 300, and wherein each of the function sheet 200 and the middle sheet 300 has a top-of-function-sheet sealing portion 240 and a bottom-of-function-sheet sealing portion 250 formed respectively in upper and lower portions thereof, the top-of-function-sheet sealing portion 240 and the bottom-of-function-sheet sealing portion 250 being pressed and attached to each other, and the top-of-function-sheet sealing portion 240 being formed in a position lower than the top-of-carrier sealing portion 140 so that the top-of-function-sheet sealing portion 240 is spaced downwards apart from the upper end of the middle sheet 300, and the bottom-of-function-sheet sealing portion 250 being formed in the lower end of the middle sheet 300, thereby forming a function space 230 between the function sheet 200 and the middle sheet 300, the function space 230 containing a cooling member or a heating member.

Also, it is still another object of the present invention to provide a packing container having temperature adjustment functions, including a package carrier block 100′ provided to include food or a mask pack, a functional pack block 200′ provided inside the package carrier block 100′ and including a cooling member or a heating member, wherein ammonium nitrate or urea is included as the cooling member to cause a cooling reaction under the external impacts, and wherein quicklime or burnt dolomite is included as the heating member to cause an exothermic reaction under the external impacts.

Also, it is still another object of the present invention to provide an apparatus for manufacturing a packing container having temperature adjustment functions. In this case the apparatus includes a sheet supply unit 400 for supplying a continuous carrier sheet 120 and a continuous function sheet 220 from a carrier sheet roller 110 and a function sheet roller 210 so that the continuous carrier sheet 120 and the continuous function sheet 220 are positioned in upper and lower portions of a continuous middle sheet 320 supplied from a middle sheet roller 310;

a sheet-pressing unit 410 provided with a pressing member for transversely continuously pressing the continuous carrier sheet 120 and the continuous function sheet 220 by a length of one packing container to form a side sealing portion 350 when the continuous carrier sheet 120 and the continuous function sheet 220 are positioned in the upper and lower portions of the continuous middle sheet 320;

a sheet-cutting unit 420 provided with a cutting edge for transversely cutting pressed portions of the continuous middle sheet 320, the continuous carrier sheet 120 and the continuous function sheet 220, all of which are pressed by the sheet-pressing unit 410;

a base sealing unit 500 attaching to each other the sealing portions 350 of both sides of the carrier sheet 100, the function sheet 200 and the middle sheet 300 that are cut and separated by the sheet-cutting unit 420, and being provided with a first pressing portion 510 and a second pressing portion 530, the first pressing portion 510 pressing an opened front end 330 of the middle sheet 300 and the carrier sheet 100 to form a bottom-of-carrier sealing portion 150 and the second pressing portion 530 pressing an opened rear end 340 of the middle sheet 300 and the function sheet 200 to form a top-of-function-sheet sealing portion 240;

a first supply unit 600 having a carrier space 130 containing either a mask pack or foodstuffs, the carrier space 130 being formed by the side sealing portions 350 and the bottom-of-carrier sealing portion 150 of both sides of the middle sheet 300 and the carrier sheet 100;

a first sealing unit 610 pressing inlets of the middle sheet 300 and the carrier sheet 100 to seal the carrier space 130;

a second supply unit 620 containing one selected from the group consisting of a coolant, a heating material and foodstuffs in the function space 230 comprising a cooling member or a heating member, the function space 230 being formed by the side sealing portions 350 and the top-of-function-sheet sealing portion 240 of both sides of the middle sheet 300 and the function sheet 200; and

a second sealing unit 630 pressing inlets of the middle sheet 300 and the function sheet 100 to seal the function space 230.

Also, it is yet another object of the present invention to provide a method for manufacturing a packing container having temperature adjustment functions. In this case, the method includes:

supplying each of a continuous middle sheet 320, a continuous carrier sheet 120 and a continuous function sheet 220 so that the continuous carrier sheet 120 and the continuous function sheet 220 are positioned in upper and lower portions of the continuous middle sheet 320 supplied from a middle sheet roller 310 (S100);

transversely continuously pressing the continuous carrier sheet 120 and the continuous function sheet 220 by a width of one packing container to form a side sealing portion 350 when the carrier sheet 100 and the function sheet 200 are positioned in the upper and lower portions of the middle sheet 300 (S200);

transversely cutting the side sealing portions 350 of the middle sheet 300, the carrier sheet 100 and the function sheet 200 in the middle while pressing the side sealing portions 350 (S300); and

pressing and sealing one opened side of the middle sheet 300 and the carrier sheet 100 to form a bottom-of-carrier sealing portion 150 and pressing and sealing the other opened side of the middle sheet 300 and the function sheet 200 to form a top-of-function-sheet sealing portion 240 (S400).

According to an aspect of the present invention, there is provided a packing container capable of containing two different contents in one packing container by forming two different spaces in different sides of one packing container.

According to another aspect of the present invention, there is also provided a packing container having an advantage in that although only a mask pack such a cold pack for masks and a hot pack for masks is pulled out and used, contents in the other packing space are not leaked out since a cut portion and a sealed portion are formed in different positions, which makes it possible to use the mask pack conveniently.

According to still another aspect of the present invention, there is provided a packing container that may be used in adequate conditions by warming or cooling the contents.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view showing a system for manufacturing a packing container according to one exemplary embodiment of the present invention,

FIGS. 2 to 6 are schematic views showing a process for manufacturing a packing container according to one exemplary embodiment of the present invention,

FIGS. 7 to 14 are schematic views showing a process for packing contents into a packing container according to one exemplary embodiment of the present invention,

FIG. 15 is a cross-sectional view showing a packing container according to one exemplary embodiment of the present invention,

FIGS. 16 and 17 are cross-sectional views showing one exemplary embodiment of a packed packing container according to one exemplary embodiment of the present invention,

FIG. 18 is a schematic view showing a packing container according to another exemplary embodiment of the present invention, and

FIG. 19 is a block view showing a system for manufacturing a packing container according to one exemplary embodiment of the present invention.

### BRIEF DESCRIPTION OF MAJOR PARTS IN THE DRAWINGS

10: packing container
11: manufacturing apparatus
100: carrier sheet
200: function sheet
300: middle sheet
350: side sealing portion

### DETAILED DESCRIPTION OF THE PREFERRED EMBODIMENT

Exemplary embodiments of the present invention will now be described in detail with reference to the accompanying drawings.

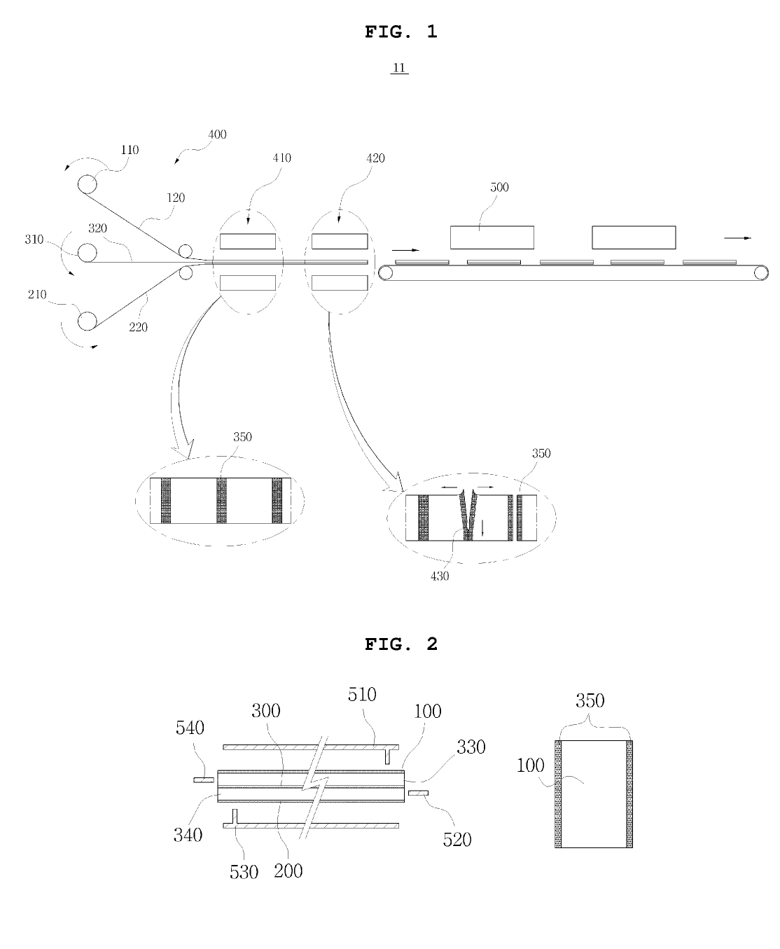

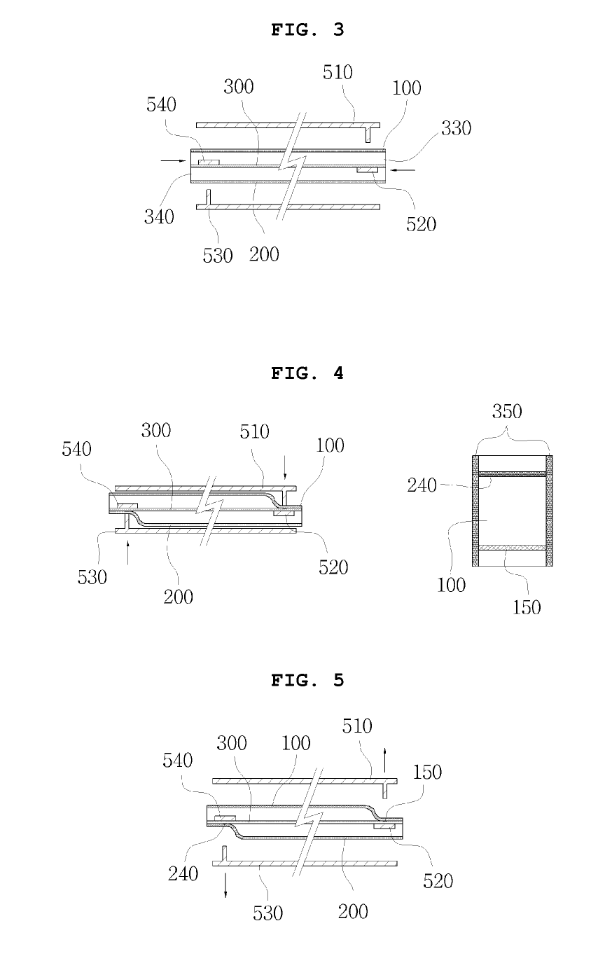

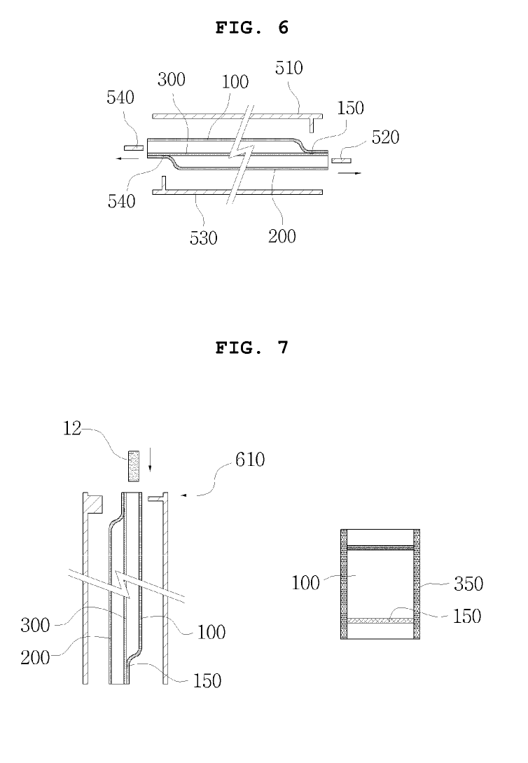

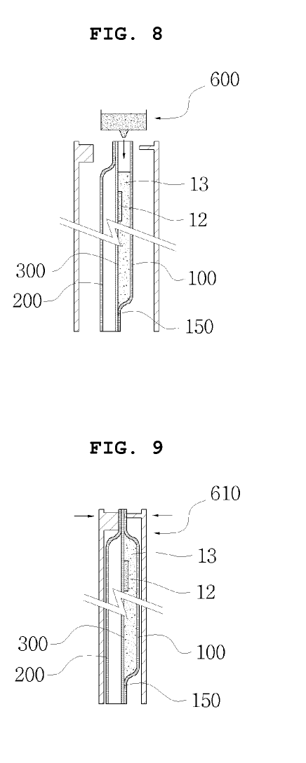

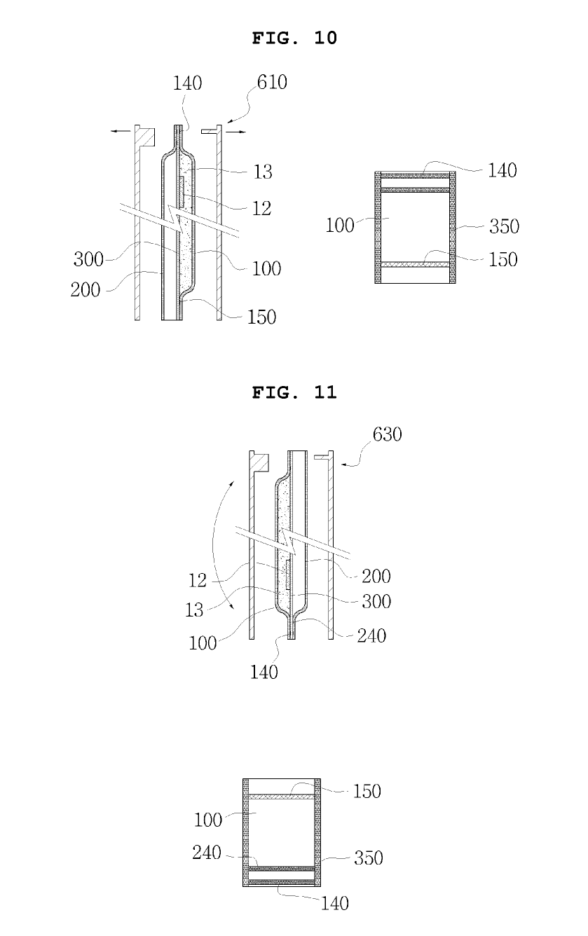

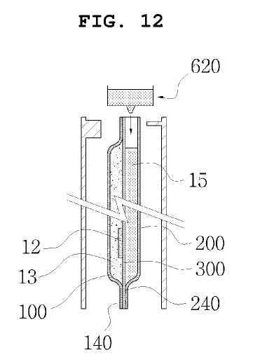

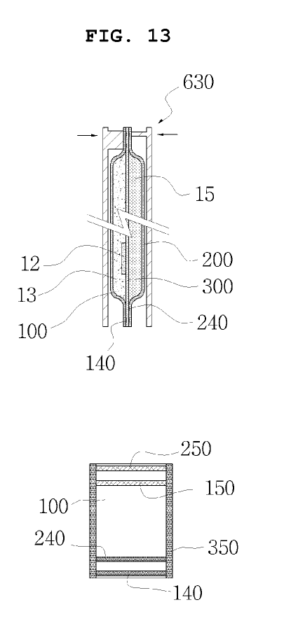

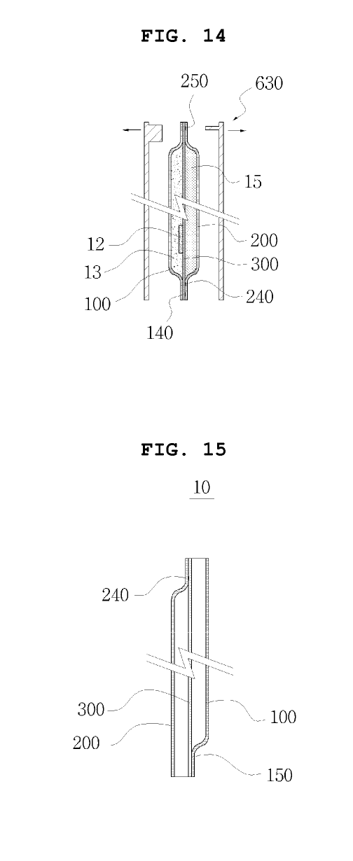

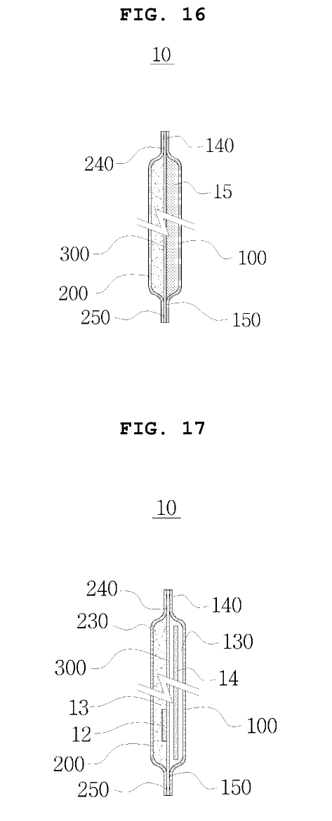

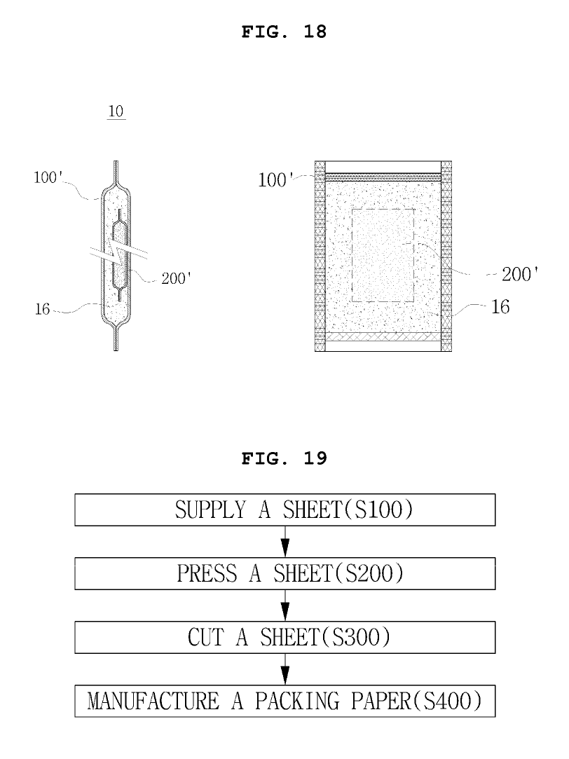

FIG. 1 is a schematic view showing a system for manufacturing a packing container according to one exemplary embodiment of the present invention, FIGS. 2 to 6 are schematic views showing a process for manufacturing a packing container according to one exemplary embodiment of the present invention, FIGS. 7 to 14 are schematic views showing a process for packing contents into a packing container according to one exemplary embodiment of the present invention, FIG. 15 is a cross-sectional view showing a packing container according to one exemplary embodiment of the present invention, FIGS. 16 and 17 are cross-sectional views showing one exemplary embodiment of a packed packing container according to one exemplary embodiment of the present invention, FIG. 18 is a schematic view showing a packing container according to another exemplary embodiment of the present invention, and FIG. 19 is a block view showing a system for manufacturing a packing container according to one exemplary embodiment of the present invention.

That is to say, the packing container 10 having temperature adjustment functions according to one exemplary embodiment of the present invention includes a carrier sheet 100, a function sheet 200 and a middle sheet 300, each of which has side sealing portions 350 formed in both side edges thereof, as shown in FIGS. 1 to 19. In this case, the side sealing portion 350 are then pressed and attached to each other. That is to say, the carrier sheet 100, the function sheet 200 and the middle sheet 300 are integrally attached by side sealing portions 350 of their both sides. Here, they are pressed and hermetically attached to each other.

Then, the carrier sheet 100 and the middle sheet 300 have a top-of-carrier sealing portion 140 and a bottom-of-carrier sealing portion 150 formed respectively in upper and lower portions thereof. In this case, the top-of-carrier sealing portion 140 and the bottom-of-carrier sealing portion 150 are then pressed and attached to each other. Subsequently, the top-of-carrier sealing portion 140 is formed in the upper end of the middle sheet 300. Also, the bottom-of-carrier sealing portion 150 is formed in a position spaced downwards apart from the lower end of the middle sheet 300 and in a position higher than the bottom-of-function-sheet sealing portion 250 of the function sheet 200. Therefore, a carrier space 130 is formed between the carrier sheet 100 and the middle sheet 300.

Also, the function sheet 200 and the middle sheet 300 have a top-of-function-sheet sealing portion 240 and a bottom-of-function-sheet sealing portion 250 formed respectively in upper and lower portions thereof, as shown in FIG. 15. In this case, the top-of-function-sheet sealing portion 240 and the bottom-of-function-sheet sealing portion 250 are then pressed and attached to each other. Then, the top-of-function-sheet sealing portion 240 is formed in a position lower than the top-of-carrier sealing portion 140 so that it can be spaced downwards apart from the upper end of the middle sheet 300. Also, the bottom-of-function-sheet sealing portion 250 is formed in the lower end of the middle sheet 300. Therefore, a function space 230 is formed between the function sheet 200 and the middle sheet 300.

Accordingly, the packing container 10 according to the present invention including the carrier space 130 and the function space 230 has an advantage in that different packing contents may be contained in one packing container 10.

The contents packed in the packing container 10 having temperature adjustment functions according to the present invention, as manufactured thus, may include a hot pack for masks, a cold pack for masks and the like, as shown in FIG. 17.

That is to say, a distilled water pack 12 containing water, and a coolant including a urea powder 13 are present inside the function space 230, and a mask pack 14 is present inside the carrier space 130 so that a cold pack for masks can be provided in the carrier space 130.

Considering that the packing container 10 is used as the above-mentioned cold pack for masks, when the distilled water pack 12 of the function space 230 bursts under the external pressures, distilled water and the urea powder 13 are mixed and react to cause an endothermic reaction. The heat in the carrier space 130 is absorbed by this endothermic reaction, and the mask pack 14 in the carrier space 130 is then cooled.

When the carrier space 130 containing the cooled mask pack is cut somewhere between the top-of-carrier sealing portion 140 (i.e., the uppermost sealing portion) and the top-of-function-sheet sealing portion 240 of the middle sheet 300, the carrier space 130 is burst opened, and the cooled mask pack 14 may be pulled out of the carrier space 130, and easily used. This cold pack for masks is desirably used for human body (in particular, face, etc.) having a fever, or for beauty at hot seasons (i.e., the summer).

Since the top-of-function-sheet sealing portion 240 is kept intact in this case, the function space 230 is not opened. Therefore, urea powder and distilled water are not leaked out, which makes it possible to cleanly use the mask pack only.

Also, a hot mask pack may be provided according to the other packing practice. That is to say, a distilled water pack containing water and a heating material including quicklime are present inside the function space 230, and a mask pack is present inside the carrier space 130 so that a cold pack for masks can be provided in the carrier space 130.

This hot pack for masks is used in the same manner as that of the cold pack for masks. That is to say, a distilled water pack in the function space 230 is burst by applying pressure to the function space 230, and distilled water and quicklime are then mixed to cause an exothermic reaction. A mask pack in the carrier space 130 is warmed by this exothermic reaction, and the warmed mask pack is pulled out of the carrier space 130 by cutting the carrier space 130 somewhere between the top-of-carrier sealing portion 140 and the top-of-function-sheet sealing portion 240.

This hot pack for masks is desirably used for heat treatment of human body (in particular, face, etc.), or for keeping warmth at cold seasons (i.e., the winter).

Also, a collagen mask pack is present inside the carrier space 130, and a green-tea mask pack is present inside the function space 230. Therefore, the packing container according to the present invention may be provided so that two different mask packs can be present in one packing container.

Moreover, the packing container 10 having temperature adjustment functions according to one exemplary embodiment of the present invention may be provided to include a variety of foodstuffs. That is to say, Kimchies (such as cabbage Kimchi and pickled young radishes), side dishes (such as seasoned vegetables and side dishes), marine products or processed meats (such as dried cuttlefish, boiled fish paste and ham, and cereals (such as traditional polished rice, unpolished rice, barley corn, and miscellaneous cereals) may be packed into different spaces.

Since the packing container 10 is manufactured so that foods, foodstuffs, marine products and cereals can be present inside the carrier space 130 and the function space 230 of the packing container 10 as described above, it is possible to use one or more foodstuffs selectively and conveniently.

The process for manufacturing the above-mentioned packing container 10 having temperature adjustment functions according to one exemplary embodiment of the present invention is now described in detail, as follows. First in the manufacturing apparatus 11 as shown in FIG. 1, the process for manufacturing a packing container 10 is mainly divided into to two steps: one step of manufacturing a packing container prior to putting contents into the packing container and the other step of putting the contents into the packing container.

That is to say, the sheet supply unit 400 includes a middle sheet roller 310 supplying a continuous middle sheet 320, a carrier sheet roller 110 supplying a continuous carrier sheet 120, and a function sheet roller 210 supplying a continuous function sheet 220. Therefore, the manufacturing of the packing container is initiated by allowing the sheet supply unit 400 to position the continuous carrier sheet 120 and the continuous function sheet 220, which are supplied respectively from the carrier sheet roller 110 and the function sheet roller 210, in upper and lower portions of the continuous middle sheet 320 supplied from a middle sheet roller 310.

Then, when the continuous carrier sheet 120 and the continuous function sheet 220 are positioned in the upper and lower portions of the continuous middle sheet 320, a packing space is divided from each of the sheets by the sheet-pressing unit 410. In this case, the sheet-pressing unit 410 is provided with a pressing member to demarcate the packing space by one packing zone. This pressing member transversely continuously presses the continuous carrier sheet 120 and the continuous function sheet 220 by a length of one packing container to form a side sealing portion 350.

Also, a sheet-cutting unit 420 is provided with a cutting edge 430 for transversely cutting pressed portions (i.e., the side sealing portions 350) of the continuous middle sheet 320, the continuous carrier sheet 120 and the continuous function sheet 220, all of which are pressed by the sheet-pressing unit 410. The continuous carrier sheet 120, the continuous function sheet 220 and the continuous middle sheet 320 in the form of a continuous sheet are cut by this sheet-cutting unit 420 into unit sheets, and separated as the unit sheets integrally including a carrier sheet 100, a function sheet 200 and a middle sheet 300.

Therefore, the carrier sheet 100, the function sheet 200 and the middle sheet 300 that are cut and separated by the sheet-cutting unit 420 have side sealing portions 350 formed in both sides thereof, wherein the side sealing portions 350 are attached to each other. The packing container 10 prior to putting contents into the packing container is prepared by the base sealing unit 500 which is provided with a first pressing portion 510 and a second pressing portion 530. In this case, the first pressing portion 510 functions to press an opened front end 330 of the middle sheet 300 and the carrier sheet 100 to form a bottom-of-carrier sealing portion 150, and the second pressing portion 530 functions to press an opened rear end 340 of the middle sheet 300 and the function sheet 200 to form a top-of-function-sheet sealing portion 240.

In this case, one side of the carrier sheet 100 and one side of the middle sheet 300 are positioned and pressed between the first pressing portion 510 and the pressing plate 520, and the other side of the function sheet 200 and the other side of side of the middle sheet 300 are positioned and pressed between the second pressing portion 530 and the pressing plate 540. Then, the first pressing portion 510 and the second pressing portion 530 perform their thermal pressure reaction while they move up and down in a reverse direction. Also, the pressing plate 520 and the pressing plate 540 that are used as bottom plates of the first pressing portion 510 and the second pressing portion 530 are provided to reciprocate in a transverse direction, but are provided to move in a reverse direction.

Referring to the method for manufacturing a packing container 10 using the apparatus for manufacturing a packing container 10 having these temperature adjustment functions, the sheet supply unit 400 functions to position the continuous carrier sheet 120 and the continuous function sheet 220 in upper and lower portions of the continuous middle sheet 320 that is supplied from the middle sheet roller 310. Here, the sheet supply unit 400 performs the supplies of the continuous middle sheet 320, the continuous carrier sheet 120 and the continuous function sheet 220 (S100). As a result, the manufacturing of the packing container is prepared by arranging sheets continuously supplied from each sheet roller in an up-and-down manner.

Then, when the carrier sheet 100 and the function sheet 200 are positioned in the upper and lower portions of the middle sheet 300 by means of the sheet-pressing unit 410, the continuous carrier sheet 120 and the continuous function sheet 220 are transversely continuously pressed by a width of one packing container to form a side sealing portion 350 (S200).

Subsequently, the sheet-cutting unit 420 transversely cuts side sealing portions 350 of the middle sheet 300, the carrier sheet 100 and the function sheet 200 in the middle while pressing the side sealing portions 350 (S300).

Also, the step of manufacturing a packing paper (S400) is carried out by the base sealing unit 500 by pressing and sealing one opened side of the middle sheet 300 and the carrier sheet 100 to form a bottom-of-carrier sealing portion 150, and by pressing and sealing the other opened side of the middle sheet 300 and the function sheet 200 to form a top-of-function-sheet sealing portion 240. As a result, the manufacturing of the packing container 10 prior to putting contents into the packing container is completed.

Then, the carrier space 130 formed between the carrier sheet 100 and the middle sheet 300 has an opened upper portion, and the function space 230 formed between the function sheet 200 and the middle sheet 300 has an opened lower portion.

Therefore, in order to pack the contents, the opened portion of the carrier space 130 is positioned upwards, filled with the contents, and then sealed. In this case, the opened portion of the function space 230 is positioned downwards.

When the packing container 10 is then turned at an angle of 180°, the opened portion of the function space 230 is positioned upwards, and the function space 230 is then filled with another contents. Finally, the packing process is completed by sealing the opened portion of the function space 230.

Referring this packing process, a first supply unit 600 is provided to have a carrier space 130 containing one selected from the group consisting of a cooling member, a heating member, a mask pack and foodstuffs, as shown in FIGS. 1 to 14. In this case, the carrier space 130 is formed by the bottom-of-carrier sealing portion 350 and the side sealing portions 150 of both sides of the middle sheet 300 and the carrier sheet 100. Also, a first sealing unit 610 is provided to press inlets of the middle sheet 300 and the carrier sheet 100 to seal the carrier space 130. Accordingly, the packing operation for the carrier space 130 is completed by the first supply unit 600 and the first sealing unit 610.

A rotary unit (not shown) is further provided to be able to perform a packing operation for the function space 230 by turning the packing container 10 at an angle of 180°.

Also, a second supply unit 620 is provided so that one of a coolant, a heating material, a mask pack and foodstuffs can be contained in the function space 230 formed by the side sealing portion 350 and the top-of-function-sheet sealing portion 240 of both sides of the middle sheet 300 and the function sheet 200. Also, a second sealing unit 630 is provided to press inlets of the middle sheet 300 and the function sheet 100 to seal the function space 230. Accordingly, the packing operation for the function space 230 is completed by the second supply unit 620 and the second sealing unit 630.

That is to say, the process of putting contents into a packing container and sealing the packing container is carried out, including: supplying contents to a carrier space when each of the carrier space 130 and the function space 230 remains open; sealing the carrier space 130 containing the contents; turning the packing container at an angle of 180° after the sealing of the carrier space 130; supplying contents into the function space 230; and sealing the function space 230 containing the contents.

Then, it is possible to select and use the packing containers 10 each containing the contents.

According to another exemplary embodiment of the present invention, a package carrier block 100′ containing either foods or a mask pack 16 is also provided, and a functional pack block 200′ is present inside the package carrier block 100′ to include a cooling member or a heating member, as shown in FIG. 18.

As a result, ammonium nitrate or urea is included as the cooling member to cause a cooling reaction under the external impacts, and quicklime or burnt dolomite is included as the heating member to cause an exothermic reaction under the external impacts.

As a result, when the cooling member containing ammonium nitrate or urea is included in the functional pack block 200′, the external impacts are applied to the functional pack block 200′ including a cooling member in order to cool and use the foods or the mask pack. Then, the cooling member is autonomously cooled to cool the foods or the mask pack in the package carrier block 100′, and may be used freshly and refreshingly.

On the contrary, when the heating member including quicklime or burnt dolomite is included in the functional pack block 200′, the external impacts are applied to the functional pack block 200′ including a heating member in order to heat and use the foods or the mask pack. Then, the heating member is autonomously heated to warm the foods or the mask pack in the package carrier block 100′, and may be used warmly.

As described above, when the foods or the mask pack is put into the package carrier block 100′, a temperature of the foods or the mask pack is adjusted to a hot or cool temperature through the temperature adjustment functions, for example cooling or heating the functional pack block 200′ present together with the foods or the mask pack.

As described above, the packing container according to one exemplary embodiment of the present invention has the excellent effect of containing two different contents in one packing container by forming two different spaces in different sides of one packing container.

Also, the packing container according to one exemplary embodiment of the present invention has an advantage in that although only a mask pack such a cold pack for masks and a hot pack for masks is pulled out and used, contents in the other packing space are not leaked out since a cut portion and a sealed portion are formed in different positions, which makes it possible to use the mask pack conveniently. Furthermore, the packing container according to one exemplary embodiment of the present invention has an advantage in that it may be used in adequate conditions by warming or cooling the contents.

While the present invention has been shown and described in connection with the exemplary embodiments, it will be apparent to those skilled in the art that modifications and variations can be made without departing from the scope of the invention as defined by the appended claims.

1. A packing container having temperature adjustment functions,
wherein each of a carrier sheet, a function sheet and a middle sheet has side sealing portions formed in both sides thereof, the side sealing portions being pressed and attached to each other,
wherein each of the carrier sheet and the middle sheet has bottom-of-carrier sealing portions formed in lower portions thereof, the bottom-of-carrier sealing portions being pressed and attached to each other and being formed in a position spaced upwards apart from the lower end of the middle sheet, thereby forming a carrier space between the carrier sheet and the middle sheet, the carrier space having an opened upper portion, and
wherein each of the function sheet and the middle sheet has top-of-function-sheet sealing portions formed in upper portions thereof, the top-of-function-sheet sealing portions being pressed and attached to each other and being formed in a position spaced downwards apart from the upper end of the middle sheet, thereby forming a function space between the function sheet and the middle sheet, the function space having an opened lower portion and containing at least one of a cooling member and a heating member.

2. A packing container having temperature adjustment functions,
wherein each of a carrier sheet, a function sheet and a middle sheet has side sealing portions formed in both sides thereof, the side sealing portions being pressed and attached to each other,
wherein each of the carrier sheet and the middle sheet has a top-of-carrier sealing portion and a bottom-of-carrier sealing portion formed respectively in upper and lower portions thereof, the top-of-carrier sealing portions and the bottom-of-carrier sealing portions being pressed and attached to each other, and the top-of-carrier sealing portions being formed in the upper end of the middle sheet and the bottom-of-carrier sealing portions being formed in a position higher than bottom-of-function-sheet sealing portions of the function sheet so that the bottom-of-carrier sealing portions are spaced upwards apart from the lower end of the middle sheet, thereby forming a carrier space between the carrier sheet and the middle sheet, and
wherein each of the function sheet and the middle sheet has a top-of-function-sheet sealing portion and a bottom-of-function-sheet sealing portion formed respectively in upper and lower portions thereof, the top-of-function-sheet sealing portions and the bottom-of-function-sheet sealing portions being pressed and attached to each other, and the top-of-function-sheet sealing portions being formed in a position lower than the top-of-carrier sealing portions so that the top-of-function-sheet sealing portions are spaced downwards apart from the upper end of the middle sheet, and the bottom-of-function-sheet sealing portions being formed in the lower end of the middle sheet, thereby forming a function space between the function sheet and the middle sheet, the function space containing at least one of a cooling member and a heating member.

3. A packing container having temperature adjustment functions, comprising:
a package carrier block provided to include food or a mask pack,
a functional pack block provided inside the package carrier block and including a cooling member or a heating member,
wherein ammonium nitrate or urea is included as the cooling member to cause a cooling reaction under the external impacts, and
wherein quicklime or burnt dolomite is included as the heating member to cause an exothermic reaction under the external impacts.

4. An apparatus for manufacturing a packing container having temperature adjustment functions, comprising:
a sheet supply unit for supplying a continuous carrier sheet and a continuous function sheet form a carrier sheet roller and a function sheet roller so that the continuous carrier sheet and the continuous function sheet are positioned in upper and lower portions of a continuous middle sheet supplied from a middle sheet roller;
a sheet-pressing unit provided with a pressing member for transversely continuously pressing the continuous carrier sheet and the continuous function sheet by a length of one packing container to form a side sealing portion when the continuous carrier sheet and the continuous function sheet are positioned in the upper and lower portions of the continuous middle sheet;
a sheet-cutting unit provided with a cutting edge for transversely cutting pressed portions of the continuous middle sheet, the continuous carrier sheet and the continuous function sheet, all of which are pressed by the sheet-pressing unit;
a base sealing unit attaching to each other the sealing portions of both sides of the carrier sheet, the function sheet and the middle sheet that are cut and separated by the sheet-cutting unit, and being provided with a first pressing portion and a second pressing portion, the first pressing portion pressing an opened front end of the middle sheet and the carrier sheet to form a bottom-of-carrier sealing portion and the second pressing portion pressing an opened rear end of the middle sheet and the function sheet to form a top-of-function-sheet sealing portion;
a first supply unit having a carrier space containing either a mask pack or foodstuffs, the carrier space being formed by the side sealing portions and the bottom-of-carrier sealing portion of both sides of the middle sheet and the carrier sheet;
a first sealing unit pressing inlets of the middle sheet and the carrier sheet to seal the carrier space;
a second supply unit containing one selected from the group consisting of a coolant, a heating material and foodstuffs in the function space comprising a cooling member or a heating member, the function space being formed by the side sealing portions and the top-of-function-sheet sealing portion of both sides of the middle sheet and the function sheet; and
a second sealing unit pressing inlets of the middle sheet and the function sheet to seal the function space.

5. A method for manufacturing a packing container having temperature adjustment functions, the method comprising:
supplying each of a continuous middle sheet, a continuous carrier sheet and a continuous function sheet so that the continuous carrier sheet and the continuous function sheet are positioned in upper and lower portions of the continuous middle sheet supplied from a middle sheet roller;
transversely continuously pressing the continuous carrier sheet and the continuous function sheet by a width of one packing container to form a side sealing portion when the carrier sheet and the function sheet are positioned in the upper and lower portions of the middle sheet;
transversely cutting the side sealing portions of the middle sheet, the carrier sheet and the function sheet in the middle while pressing the side sealing portions; and
pressing and sealing one opened side of the middle sheet and the carrier sheet to form a bottom-of-carrier sealing portion and pressing and sealing the other opened side of the middle sheet and the function sheet to form a top-of-function-sheet sealing portion.
